(19) United States
(12) Patent Application Publication
(10) Pub. No.: US 2022/0036233 A1
(43) Pub. Date: Feb. 3, 2022

(54) MACHINE LEARNING ORCHESTRATOR

(71) Applicant: Dell Products L.P., Round Rock, TX (US)

(72) Inventor: Ally Junio Oliveira BARRA, Cork (IE)

(73) Assignee: Dell Products L.P., Round Rock, TX (US)

(21) Appl. No.: 16/943,873

(22) Filed: Jul. 30, 2020

(51) Int. Cl. G06N 20/00; H04L 29/08; G06F 11/07

(52) U.S. Cl. CPC G06N 20/00; G06F 11/0766; H04L 67/1002

(57) ABSTRACT

An information handling system may include at least one processor and a non-transitory memory coupled to the at least one processor. The information handling system may be configured to: communicatively couple to a cloud platform for execution of a task comprising one or more steps; and for each of the one or more steps: in response to a determination that the step has a parallel property associated therewith, cause the cloud platform to create a selected number n of instances of the step for parallel execution; and in response to a determination that the step does not have the parallel property associated therewith, cause the cloud platform to create a single instance of the step for sequential execution.

### TECHNICAL FIELD

The present disclosure relates in general to information handling systems, and more particularly to the management of machine learning systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system).

Various embodiments of this disclosure may be applied in the field of HCI systems. Further, some embodiments of this disclosure may be implemented using one or more cloud platforms such as Pivotal Cloud Foundry (PCF), etc.

Some embodiments of this disclosure may employ artificial intelligence (AI) techniques such as machine learning, deep learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

It is desirable to automate various machine learning workflows in a cloud platform so that data can be transformed and correlated together in a model that can be tested and evaluated to achieve the best result. Accordingly, it may be beneficial to have the ability to perform tasks both sequentially and in parallel.

For example, sequential tasks may be needed for the training workflows (e.g., in order to perform the training, the training data would typically need to be cleaned first). For several other problems in pipeline development, it may be advantageous to perform some tasks in parallel. This is the case with, for example, hyper-tuning tasks where a server and several clients are used to achieve the best set of parameters for a given model. According to some embodiments of this disclosure, a machine learning orchestrator may be used in these and other situations to manage and perform tasks more efficiently and safely.

It should be noted that, although this disclosure describes the example of HCI systems and PCF in detail for the sake of clarity and exposition, various aspects of this disclosure may in some embodiments be applied to traditional datacenters, individual compute/storage/networking devices, virtual machines, etc.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of machine learning systems may be reduced or eliminated.

In accordance with embodiments of the present disclosure, an information handling system may include at least one processor and a non-transitory memory coupled to the at least one processor. The information handling system may be configured to: communicatively couple to a cloud platform for execution of a task comprising one or more steps; and for each of the one or more steps: in response to a determination that the step has a parallel property associated therewith, cause the cloud platform to create a selected number n of instances of the step for parallel execution; and in response to a determination that the step does not have the parallel property associated therewith, cause the cloud platform to create a single instance of the step for sequential execution.

In accordance with these and other embodiments of the present disclosure, a method may include an information handling system communicatively coupling to a cloud platform for execution of a task comprising one or more steps; and for each of the one or more steps, the information handling system: in response to a determination that the step has a parallel property associated therewith, causing the cloud platform to create a selected number n of instances of the step for parallel execution; and in response to a determination that the step does not have the parallel property associated therewith, causing the cloud platform to create a single instance of the step for sequential execution.

In accordance with these and other embodiments of the present disclosure, an article of manufacture may include a non-transitory, computer-readable medium having computer-executable code thereon that is executable by an information handling system for: communicatively coupling to a cloud platform for execution of a task comprising one or more steps; and for each of the one or more steps: in response to a determination that the step has a parallel property associated therewith, causing the cloud platform to create a selected number n of instances of the step for parallel execution; and in response to a determination that the step does not have the parallel property associated therewith, causing the cloud platform to create a single instance of the step for sequential execution.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIGS. 2 and 3 illustrate example schemas for sequential and parallel tasks, in accordance with embodiments of the present disclosure;

FIG. 4 illustrates an example method, in accordance with embodiments of the present disclosure; and

FIG. 5 illustrates another example method, in accordance with embodiments of the present disclosure.

### DETAILED DESCRIPTION

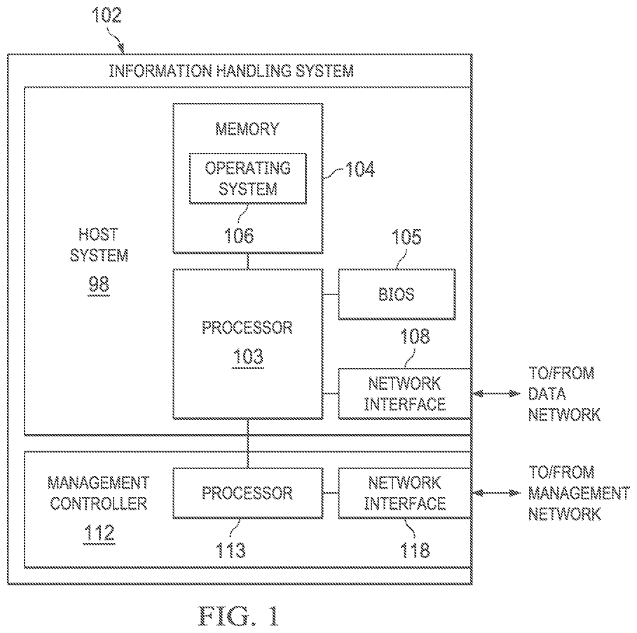

Preferred embodiments and their advantages are best understood by reference to FIGS. 1 through 5, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102 (e.g., by a user operating a management console). Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide a machine learning orchestrator for improving the management of machine learning tasks. Such an orchestrator may allow for the execution of sequential or parallel workflows in a machine learning pipeline. The orchestrator may be implemented in any combination of software, hardware, firmware, etc. The orchestrator may execute on an information handling system such as information handling system 102, and it may communicatively couple to a cloud service (e.g., PCF) via a network connection.

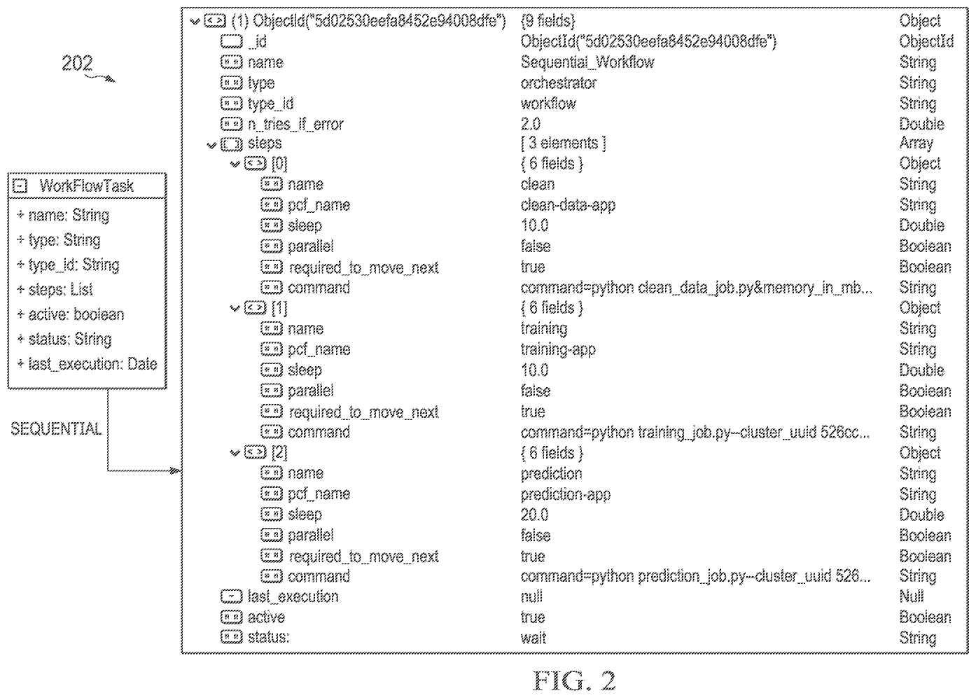

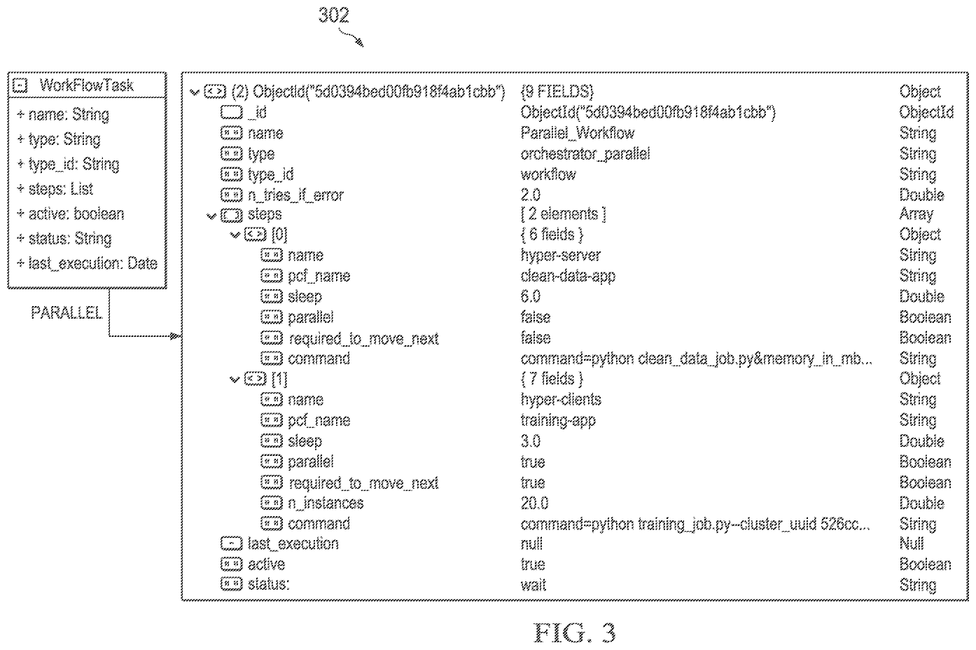

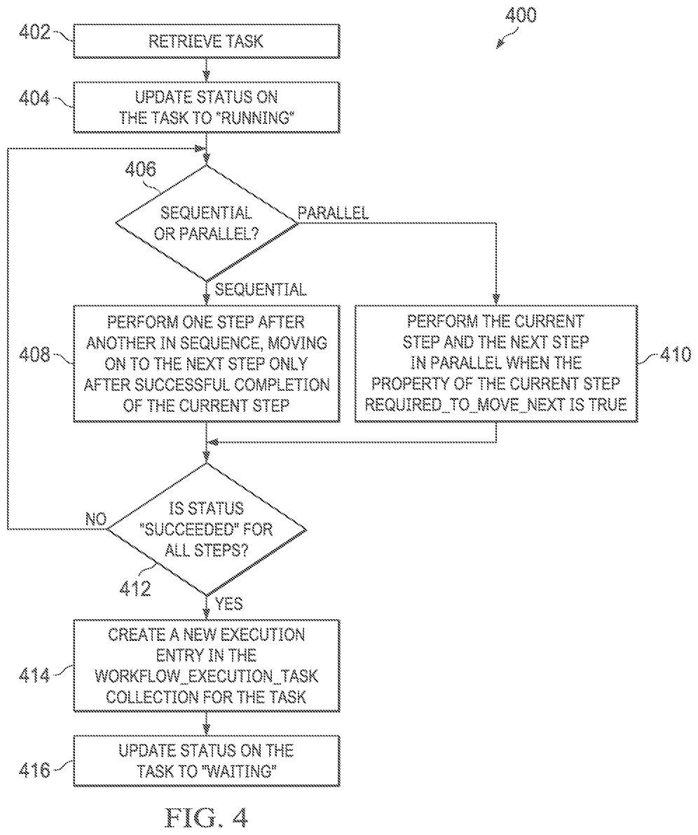

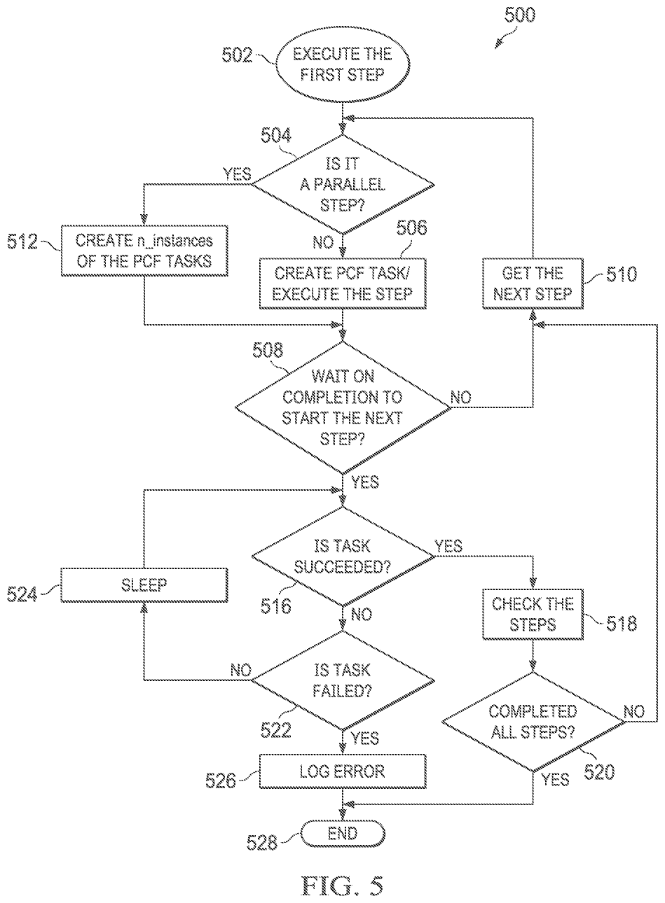

As discussed in more detail below with respect to FIGS. 2 and 3, the workflows implemented via the orchestrator may be defined without the need to write code, thus standardizing all workflows and minimizing the time required to execute a new workflow. Once a workflow record is created, the orchestrator can execute the steps defined in the workflow in a parallel and/or sequential way as defined in the configuration of each step. Further details regarding parallel and sequential execution are discussed below with respect to FIGS. 4 and 5.

At a high level, for each step to be performed, the orchestrator may check whether the step should be executed in parallel or sequentially. If the step is parallel, the orchestrator may create a number (e.g., a number n which may be configurable) of instances of this step and wait for all of them to execute before running the next step (if there is a next step). If the step is sequential, the orchestrator may create the single instance of the step and wait for its execution to finish, then move on to the next step (if there is a next step).

For both types of steps, the same error handling and the same execution flow may be implemented. Further details are discussed below with regard to FIG. 5.

For purposes of this disclosure, a task is the instance of a step in a cloud platform scheduler such as the PCF scheduler. Such a step can be either parallel or sequential.

For purposes of this disclosure, parallel execution is the performance of two or more tasks at the same instant of time. Sequential execution, in contrast, is the performance of the next task after finishing the current task.

Parallel steps may determine the creation of n_instances of the same step. A default may be implemented to determine the creation of only one instance of the step, and the number n may be configurable. In various embodiments, a step may have to end to advance to the next step, or the next step can be invoked during the execution of a given step.

According to some embodiments, an orchestrator may manage the creation and execution of the task (workflow), and create an instance for each step of working on the cloud platform as a task. Further, some embodiments may include fault tolerance, such that when a given process fails, a configurable number of attempts may be initiated for the orchestrator to try again to perform the task successfully.

Some non-limiting examples of workflows that may be executed according to embodiments of the present disclosure may include cleaning data, training, and prediction. Cleaning data may comprise a workflow that fills gaps in data such as time-series data. Training may train new models of machine learning. And prediction may make new predictions of the future based on a model.

Turning now to FIG. 2, an example schema 202 for a sequential workflow task is shown. As can be seen, each step in this sequential task has the property parallel set to “false.”

Similarly, in FIG. 3, an example schema 302 for a parallel workflow task is shown. As can be seen, step [1] in schema 302 has the property parallel set to “true.” One of ordinary skill in the art with the benefit of this disclosure will appreciate that the data illustrated in FIGS. 2 and 3 is merely one example of the types of data that might be included in such a schema.

Turning now to FIG. 4, a flow chart is shown of an example method 400 for operating a machine learning orchestrator, in accordance with some embodiments of this disclosure. At step 402, a task may be retrieved by the orchestrator. At step 404, a status flag or variable for the task may be updated to a “running” status.

For each step of the task, at step 406, a determination may be made as to whether the step is a sequential step or a parallel step. If the step is sequential, execution of the step of the task may begin at step 408. At step 408, the step may execute in a sequential fashion, such that steps are performed one after another, with execution moving on to the next step only after successful completion of the current step.

If, on the other hand, the step is parallel, execution of the step of the task may begin at step 410. At step 410, the step may execute in a parallel fashion, such that the current step and the next step are performed in parallel when the property required to move next of the current step is true.

This process may loop at step 412 until the status for all steps has been updated to “succeeded.”

At step 414, a new execution entry in the workflow execution task collection for the task may be created. At step 416, the status of the task may be updated to “waiting.” After step 416, the method may end.

One of ordinary skill in the art with the benefit of this disclosure will understand that the preferred initialization point for the method depicted in FIG. 4 and the order of the steps comprising that method may depend on the implementation chosen. In these and other embodiments, this method may be implemented as hardware, firmware, software, applications, functions, libraries, or other instructions. Further, although FIG. 4 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Turning now to FIG. 5, a flow chart is shown of another example method 500 for operating a machine learning orchestrator, in accordance with some embodiments of this disclosure. At step 502, execution of the first step of a task may be initiated. A determination may be made at step 504 as to whether the step is parallel. If not, a PCF task may be created, and the step may execute at step 506. If, on the other hand, the step is parallel, then a number n (e.g., defined in the n instances property) of the PCF tasks may be created at step 512, and they may begin execution in parallel.

At step 508, a determination may be made as to whether the process should wait on completion of the step to start the next step. If not, the method may proceed to step 510, and the next step may be retrieved. If so, the method may proceed to step 516.

If the task has a “succeeded” status at step 516, then the orchestrator may check the steps of the task at step 518. If all steps are completed at step 520, then the method may end at step 528. If all steps are not yet completed, then the method may return to step 510, and the next step may be retrieved.

If a determination is made at step 516 that the task does not have the status “succeeded,” then at step 522, a determination may be made as to whether the task has the status “failed.” If so, an error may be logged at step 526 (e.g., by sending an email to a user of the orchestrator), and the method may end at step 528.

If the task does not have either the “succeeded” or “failed” status, then the orchestrator may sleep (e.g., for a configurable or predetermined amount of time) at step 524, and the method may then return to step 516.

One of ordinary skill in the art with the benefit of this disclosure will understand that the preferred initialization point for the method depicted in FIG. 5 and the order of the steps comprising that method may depend on the implementation chosen. In these and other embodiments, this method may be implemented as hardware, firmware, software, applications, functions, libraries, or other instructions. Further, although FIG. 5 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Accordingly, embodiments of this disclosure may provide various benefits. For many machine learning solutions, the execution of sequential and parallel workflows is required. However, there has heretofore been no standard solution in cloud platforms such as PCF that allows for orchestration of such sequential and parallel workflows.

Embodiments of this disclosure may effectively solve the management, execution, and monitoring of workflows on cloud platforms such as PCF.

Sequential tasks may be useful in situations in which a workflow requires the execution of other workflows first. For example, in the case of a training workflow, before training a model, some pre-processing of the data may be carried out to clean the data and fill in gaps for better results in the training phase. Pre-processing is thus used to provide better results.

Embodiments of this disclosure may obviate the need to write dozens, and in some cases hundreds, of lines of code to solve each of the problems described. One embodiment may manage, execute, and monitor the different streams discussed herein in a more agile way.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory memory coupled to the at least one processor;
wherein the information handling system is configured to:
communicatively couple to a cloud platform for execution of a task comprising one or more steps; and
for each of the one or more steps:
in response to a determination that the step has a parallel property associated therewith, cause the cloud platform to create a selected number n of instances of the step for parallel execution; and
in response to a determination that the step does not have the parallel property associated therewith, cause the cloud platform to create a single instance of the step for sequential execution.

2. The information handling system of claim 1, wherein the task is a machine learning task.

3. The information handling system of claim 1, wherein the selected number n is configurable by a user.

4. The information handling system of claim 1, wherein the configurable number n is stored in a schema associated with the task.

5. The information handling system of claim 1, wherein the information handling system is further configured to log an error in response to a determination that at least one step of the task has failed.

6. The information handling system of claim 5, wherein logging the error comprises sending an email to a user.

7. A method comprising:
an information handling system communicatively coupling to a cloud platform for execution of a task comprising one or more steps; and
for each of the one or more steps, the information handling system:
in response to a determination that the step has a parallel property associated therewith, causing the cloud platform to create a selected number n of instances of the step for parallel execution; and
in response to a determination that the step does not have the parallel property associated therewith, causing the cloud platform to create a single instance of the step for sequential execution.

8. The method of claim 7, wherein the task is a machine learning task.

9. The method of claim 7, wherein the selected number n is configurable by a user.

10. The method of claim 7, wherein the configurable number n is stored in a schema associated with the task.

11. The method of claim 7, further comprising logging an error in response to a determination that at least one step of the task has failed.

12. The method of claim 11, wherein logging the error comprises sending an email to a user.

13. An article of manufacture comprising a non-transitory, computer-readable medium having computer-executable code thereon that is executable by an information handling system for:
communicatively coupling to a cloud platform for execution of a task comprising one or more steps; and
for each of the one or more steps:
in response to a determination that the step has a parallel property associated therewith, causing the cloud platform to create a selected number n of instances of the step for parallel execution; and
in response to a determination that the step does not have the parallel property associated therewith, causing the cloud platform to create a single instance of the step for sequential execution.

14. The article of claim 13, wherein the task is a machine learning task.

15. The article of claim 13, wherein the selected number n is configurable by a user.

16. The article of claim 13, wherein the configurable number n is stored in a schema associated with the task.

17. The article of claim 13, wherein the code is further executable for logging an error in response to a determination that at least one step of the task has failed.

18. The article of claim 17, wherein logging the error comprises sending an email to a user.
